(19) United States
(12) Patent Application Publication
(10) Pub. No.: US 2022/0398628 A1
(43) Pub. Date: Dec. 15, 2022

(54) ADVERTISING ONLINE BETWEEN FREE-PLAY NUMBER GAMES

(71) Applicant: Alan Frank, Pittsburgh, PA (US)

(72) Inventor: Alan Frank, Pittsburgh, PA (US)

(21) Appl. No.: 17/346,317

(22) Filed: Jun. 14, 2021

(51) Int. Cl. G06Q 30/02

(52) U.S. Cl. CPC G06Q 30/0251

(57) ABSTRACT

The current invention's web site displays a 30-second-long advertisement every minute of the day. The remaining seconds in each minute are used to display four-digit videos of winning numbers being randomly generated for online number-matching games. The games are free to play and award valuable prizes. For each game, the digits of the winning numbers are created by randomly selecting and sequentially displaying four videos of ten balls being mixed in a transparent chamber for about seven seconds each. One ball randomly separates itself from the others. Each ball is marked with a different digit. The videos are randomly selected from a pool of 100 different pre-recorded videos of digits being randomly generated. Each digit in said pool was randomly generated ten times. The bottom ramp of the mixing chamber vibrates to prevent balls from jamming. Play is limited to one game per day unless players click on ads.

This application is being filed under 37 CFR 1.53(b) as a continuation-in-part and claims the benefit of a previous application namely, Ser. No. 16/511,763 that was filed Jul. 15, 2019, under 35 U.S.C. 120. This application repeats a substantial portion of said prior application and adds and claims additional disclosure not presented in the prior application.

The previous application and the current application have the same inventor. The previous application. has not been abandoned nor granted nor is it a provisional application.

### BRIEF DESCRIPTION OF THE DRAWINGS

FIG. 1 is a sketch of the vibrating ramp.

FIG. 2 is a side view photo of the small motor and a quarter for a sizing reference.

FIG. 3 is a photo of the motor showing the narrow diameter off-center extension rod.

FIG. 4 is a front view photo of the mixing chamber.

FIG. 5 is a rear view photo of the mixing chamber.

FIG. 6 is a side view photo of the mixing chamber and motor.

FIG. 7 is a close-up photo of the motor and the bottom lip of the ramp.

### SPECIFICATION

### Background of the Invention

Classification A63F13/61

Technique for embedding advertising information in video games.

The prior application of this continuation-in-part described an invention that addressed the desires and needs of retail merchants to attract customers to their stores by operating free-play cash-prize number selecting games every ten minutes. Play was limited to only one game per day per player.

The current invention addresses the desires and needs of internet merchants to attract users of computers, electronic tablets and cell phones to the internet merchants' virtual stores by operating free-play cash-prize online number-selecting games every minute of every day. The apparatus for operating the number-selecting games of the current invention was basically the same except for the addition of a novel vibrating ramp to prevent the balls from jamming and the creation, production and use of hundreds of recordings of digits being randomly generated to create winning numbers.

The prior invention relates generally to systems for promoting retail business, and particularly, to the operation of free-play, live draw number selecting games at 10-minute intervals throughout the day. The current invention relates generally to a method and apparatus for promoting internet business and particularly to the operation of free-play, online number selecting games at one-minute intervals throughout the day using said recordings.

Internet merchants are constantly searching for innovative methods of advertising that will help retain and expand their customer bases. For maximum effectiveness, an internet advertising program should operate automatically and continuously. It should be free and available to paying and non-paying surfers alike, and it should be enjoyable, if possible. Most importantly, since the online games of the current invention are free to play and winners receive cash prizes, it will stand alone in the class of internet advertising between video games.

Periodic sweepstakes and contests have only been moderately effective in generating internet traffic and increasing internet sales. Traditional methods of offering discounts and special sales do not seem to be as effective as of late. Providing internet surfers with free prizes standing alone would lead to overuse abuse, inasmuch as opportunists would take advantage of the ability to visit a website repeatedly. Accordingly, a need exists for a novel method of advertising that that includes anxiety, joy and surprise, that requires little effort, that is free, that does not require human intervention, is not susceptible to overuse and that awards prizes 24 hours a day.

Live draw bouncing ball number-selecting games have achieved a high level of popularity and respectability because of their high level of anxiety, joy and surprise. Historically, the numbers on the balls were identified by human eyes as described in U.S. Pat. No. 4,601,471. The necessity of human intervention was almost eliminated by using bar-coded balls as described in U.S. Pat. No. 5,088,737. The necessity of human observation was finally eliminated by using differently colored balls as described in U.S. Pat. No. 9,751,002. With that invention, automatic live draw generation of random numbers without requiring human eye identification finally became a reality.

To reach its maximum potential as an online advertising program, a free-play number selecting game should operate frequently all day every day of the year. The random number generating process should be “live-draw” if possible and virtual if not. It should be completely visible at all times and should be free of human intervention and completely automatic. All those features enhance public trust.

The time span between number selecting games should be brief so that the players can enjoy prompt satisfaction. Accordingly, in the current invention the time span between number selecting games is set at one minute. Every 24 hours, there are 1,440 different number-selecting games.

The current invention also addresses the issue of establishing the optimum prize amount. Advertising revenue will be the dominant factor. As it increases, so does the prize amount.

### SUMMARY OF THE INVENTION

A preferred embodiment of the apparatus of the current invention includes a transparent mixing chamber containing ten balls like the apparatus described in the prior application. Each ball is marked with a different digit. The digit is printed at multiple locations on the surface of each ball so that regardless of a ball's orientation, viewers will recognize the digit.

The mixing chamber of the prior invention was functional but not perfect. Occasionally, when the blower stopped, the balls on the center-bottom ramp of the mixing chamber jammed, thereby preventing a ball from falling onto the color sensor mounted to the bottom of the settlement pocket.

One novel feature of the apparatus of the current invention is the creation and addition of a separate ramp at the bottom center area of the mixing chamber. The top of the ramp is loosely attached to the back wall of the mixing chamber with two wires. In a preferred embodiment of said ramp, its bottom edge is bent downward to form a flap. There is a hole in the center of the flap.

A small 1.5-volt motor is mounted to the base of the mixing chamber below the ramp. The end of the shaft of the motor has a narrow diameter off-center extension rod that extends through the hole in the downward flap. The diameter of the hole is larger than the diameter of the extension rod and smaller than the diameter of the shaft. The upper rim portion of the hole in the downward flap of the ramp rests on said extension rod.

The small motor can be automatically powered either by a 1.5-volt battery or by 110-volt source to which a 110 to 1.5 volt, ac-dc transformer-converter is connected.

When the blower stops running and the balls stop mixing, the small motor begins running. The bottom of the ramp vibrates upward and downward as the out-of-round motor shaft rotates, thereby preventing the balls from jamming or un-jamming them if they do jam.

A preferred method of using said apparatus includes operation of a web site where visitors can play online number-selecting games every minute of every day without paying anything and can win big cash prizes. Advertisements are displayed between games. Play is limited to one play per day per player. Additional playing opportunities are awarded to players who click on the advertisements. Players can view ads before or after selecting their numbers.

Ten audio-video recordings of each digit being randomly generated by said apparatus have been produced and are saved in a pool of 100 recordings at the web site server. No two recordings are identical. Each recording runs for about seven seconds.

Every minute of every day, 1,440 times a day, the software of the current invention randomly selects four recordings from said pool. None of the four selected recordings is selected more than once.

Software of the preferred version of the current invention commands display of the four selected videos sequentially. The total time required to display the four recordings sequentially is about 28 seconds. In alternative versions of the current invention, display of the four selected recordings overlaps and the total display time is shorter, thereby allowing for advertisements of greater than 30-seconds in length.

Using four-digit numbers is optimal for various reasons. If winning numbers consisted of less than four digits, wins would occur too often and prize amounts would be limited to amounts smaller than $100.00. Fewer internet users would be attracted. If winning numbers consisted of more than four digits, Wins would occur too rarely, and players would lose interest.

The display of advertisements itself includes a hyperlink which, if clicked on, will transfer the clicker to the internet site desired by the advertiser.

A preferred embodiment of the invention software enables internet surfers who visit the web site to register and log in. A welcome screen informs the visitors that they can win big cash prizes without paying any money simply by selecting a four-digit number and provides other information. The welcome screen also serves as a method of quickly and efficiently getting all logged in players viewing the same pages of the website simultaneously, regardless of when, in a particular minute, they log in.

The welcome screen is displayed to everyone immediately upon logging in. Players who log in during the first 30 seconds of a minute will continue viewing the welcome screen until the halfway point of the minute at which time they will begin viewing an advertisement for 30 seconds. If the log in occurs during the last 30 seconds of the minute, the welcome screen will be displayed until the beginning of the next minute at which time they will begin viewing the four selected videos of balls being mixed for 30 seconds. Players are permitted to select numbers during the ball-mixing segment of every minute, but not during display of advertisements.

If a player's selected number becomes matched by the next winning number or by another subsequently generated winning number, (if the player clicked an ad), the player wins the cash prize then prevailing. The amount of the prize will vary as the advertising revenue varies. Payments are made electronically to the player's email addresses through customary commercial money handlers.

A player who clicks on an ad will be transferred out of the invention web site temporarily and will be permitted to play two games when he/she returns. Players who do not click on an ad can play one game per day.

Players may continue surfing on the internet after clicking on an ad. They can return to the invention web site with conventional internet navigation tools. In a preferred configuration of the current invention, upon return, surfers will be shown the welcome screen as though they just logged in. Alternative configurations include timing the return of surfers so that they enter the invention web site just in time to see the beginning of a ball-mixing segment of the game during which they can select numbers for the subsequent game. The winning number produced by such a delayed ball-mixing segment constitutes the “NEXT” winning number for purposes of determining if the player's selected number becomes matched by a “NEXT” winning number.

### DETAILED DESCRIPTION OF THE CURRENT INVENTION

The following four novel concepts of the current invention have been brought to fruition with novel methods and apparatus:
1. The operation of online number-selecting games at a web site where players can win big cash prizes any minute of every day without paying anything.
2. The use of a small motor with an off-center shaft to make the bottom ramp of the ball-mixing chamber of a random digit generator vibrate, thereby preventing the balls from jamming.
3. The enabling of internet advertisers to display 30-second-long advertisements between said number-selecting games.
4. The creation of a pool of video recordings of digits being randomly generated by said ball-mixing chamber, the random selection and display of four of said recordings for each game and the use of the four digits displayed in said recordings to form the winning numbers of said games.

### 1. Operating Online Number-Guessing Games Every Minute

In the prior invention, four-digit number-guessing games were operated in retail stores every ten minutes to attract foot traffic. Play was free and cash prizes of $1,000.00 were awarded to any shopper who selected a four-digit number that became matched by the next randomly generated four-digit number. Ten real differently numbered balls were air-mixed in an enclosed chamber until one ball randomly separated itself from the others. Its digit became the first digit of the next winning number. The mixing process was repeated three times to form a four-digit winning number. The ball-mixing processes were displayed on huge screens in the retail store. It was not necessary to create and maintain a full-time web site.

In the current invention, the objective is to attract internet customers every minute of every day which requires completely novel concepts and hardware and software, such as a web site and complete automation.

The current invention maintains a web site with a URL of www.free-pick4-lotto.com The web site consists of customary informative pages. In order to play the number-guessing games, a visitors must first register using a nickname, email address and a password. A verification message is sent to the email address. The email address owner must click on the verification link within 20 minutes to complete registration. The click transfers the clicker to a small log in screen.

After logging in with the email and password, a full-size welcome screen is displayed. If the log in occurs during the first 30 seconds of a minute, the player will continue viewing the welcome screen until the 30^{th} second of the minute at which time, an advertisement will begin running for 30 seconds. If the log in occurs during the second 30 seconds of a minute, the welcome screen will be displayed until the beginning of the next minute at which time, four 7-second-long videos of the 10 differently numbered balls being mixed will be displayed for 28 seconds. During the ball-mixing segment of every minute, players will be permitted to select numbers.

If a player's selected number becomes matched by the next winning number or by a winning number generated subsequent to it (assuming the player clicked the next ad), the player(s) win(s) the cash prize then prevailing. The amount of the prize will vary as the advertising revenue varies. Payments are made electronically to players' email addresses through customary commercial money handlers.

A player who clicks on an ad will be transferred out of the invention web site temporarily and will be permitted to play two games when he/she returns. Players who do not click on an ad are permitted to play only one game per day.

Players may continue surfing on the internet after clicking on an ad. The winning number for those players will not be determined until they finish shopping.

Surfers may return to the invention web site with conventional browser navigation tools. In a preferred configuration of the current invention, returning surfers will be shown the welcome screen as though they just logged in. In an alternate configuration, the return of said surfers will be delayed until the beginning of a ball-mixing segment. In either configuration, the winning number for those returning surfers will constitute the NEXT four-digit number displayed to them.

In an alternate configuration, the videos and number selection segments of the current invention are displayed over conventional television networks. Cable companies enable their subscribers to select one four-digit number per month and the daily sequential game number between 1 and 1,440 in which to enter the selected number every day. When a selected number becomes matched, the prize money is credited to the customer's account. If the prize is $1,000.00, the cost to the cable company will average $3.00 per customer per month. Between ball-mixing segments, the companies can display 30-second ads to cover the cost of the prizes and generate a tidy profit.

### 2. The Vibrating Ramp and Motor

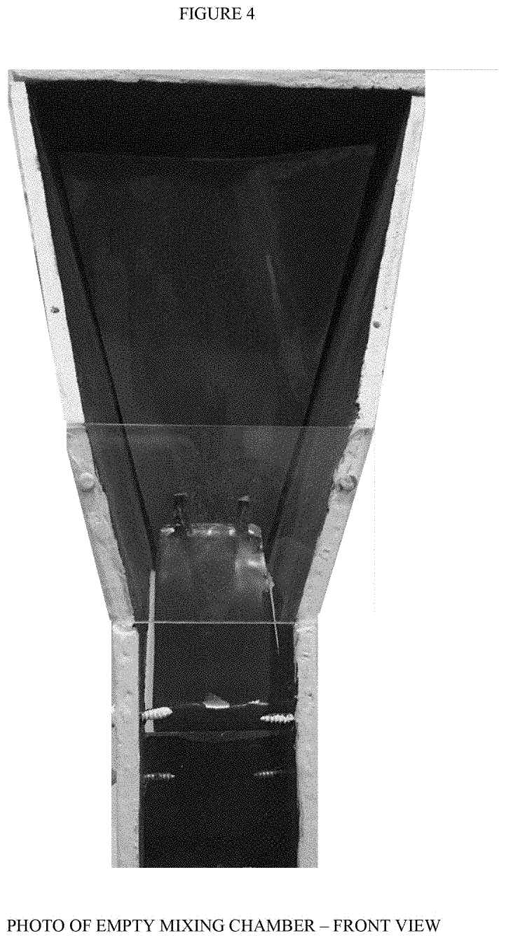

The transparent mixing chamber of the current invention shown in FIGS. 4, 5, and 6 contains 10 balls. Each ball is conspicuously marked with a different digit. The blower that mixes the balls in the mixing chamber directs air upward at an angle of 45 degrees above horizontal into the open front area of the bottom of the mixing chamber. The blower is not shown in the drawings nor in the videos. The nozzle tip of the blower is best positioned 1.25 inches away from the ball in the lower settlement pocket.

The bottom-center of the chamber contains a rear-to-front downward ramp that was conceived and created to prevent jamming of the balls during mixing. Air from the blower moves the balls from the front of the mixing chamber, up the ramp, up the back wall, then forward along the upward-sloping top wall of the chamber, then down the transparent front wall of the chamber and into the front settlement pocket where the digit on the randomly separated ball can easily be seen regardless of its orientation. The digit is marked on six different locations of a ball's surface.

When the blower stops running, the air gradually stops flowing. The gradual cessation of airflow occasionally causes the balls to jam.

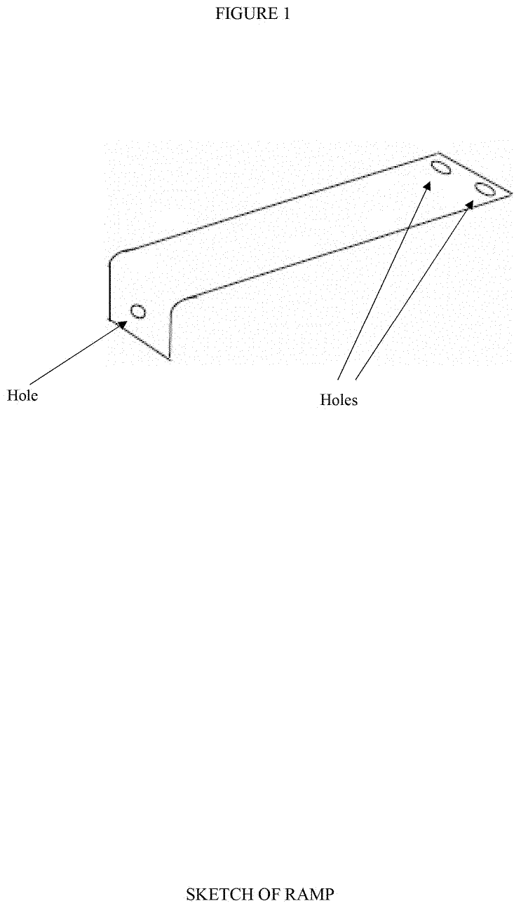

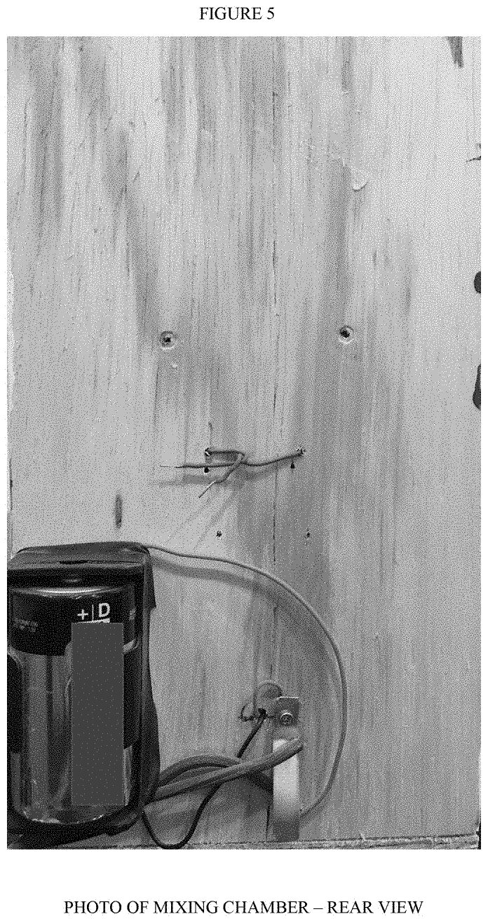

In a preferred embodiment of the current invention, the ramp shown in FIGS. 1 & 7 has a bottom vertical flap portion with a hole in the center of the flap as shown in FIG. 1. The top of the ramp has two holes as shown in FIG. 1. Small wires go through the holes and through the back wall of the mixing chamber as shown in FIG. 5. This loose method of attaching the ramp to the mixing chamber allows the bottom of the ramp to move vertically upward and downward freely.

A small 1.5-volt motor that was originally designed for electric shavers provides the vibration. The motor was designed to move the cutting head of the shaver back and forth when the shaft of the motor rotates.

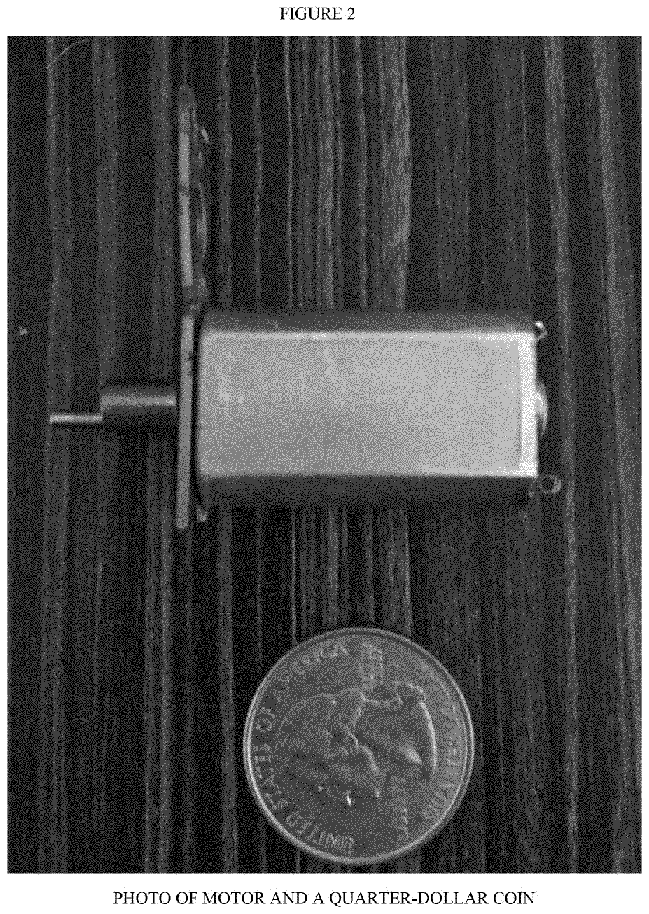

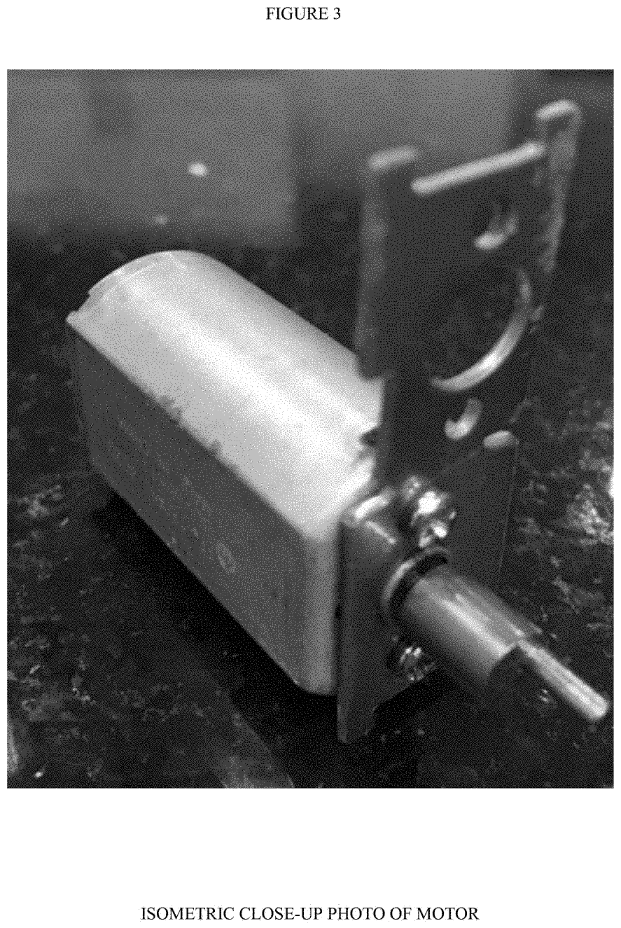

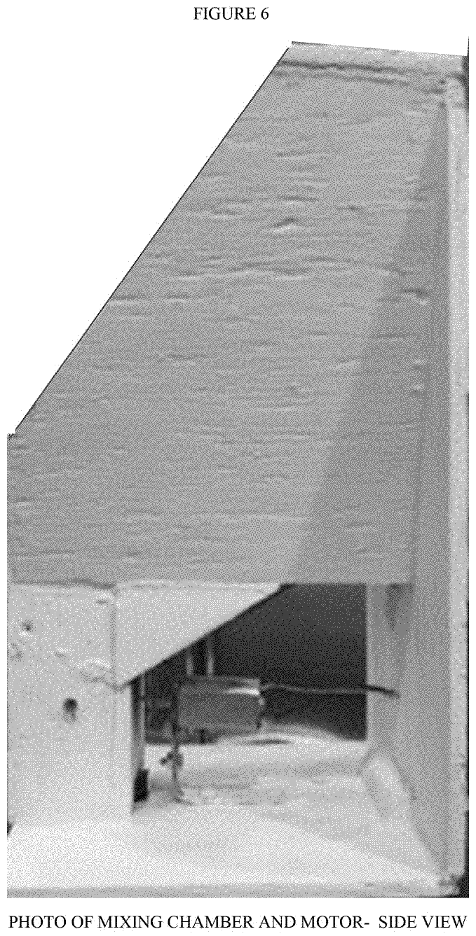

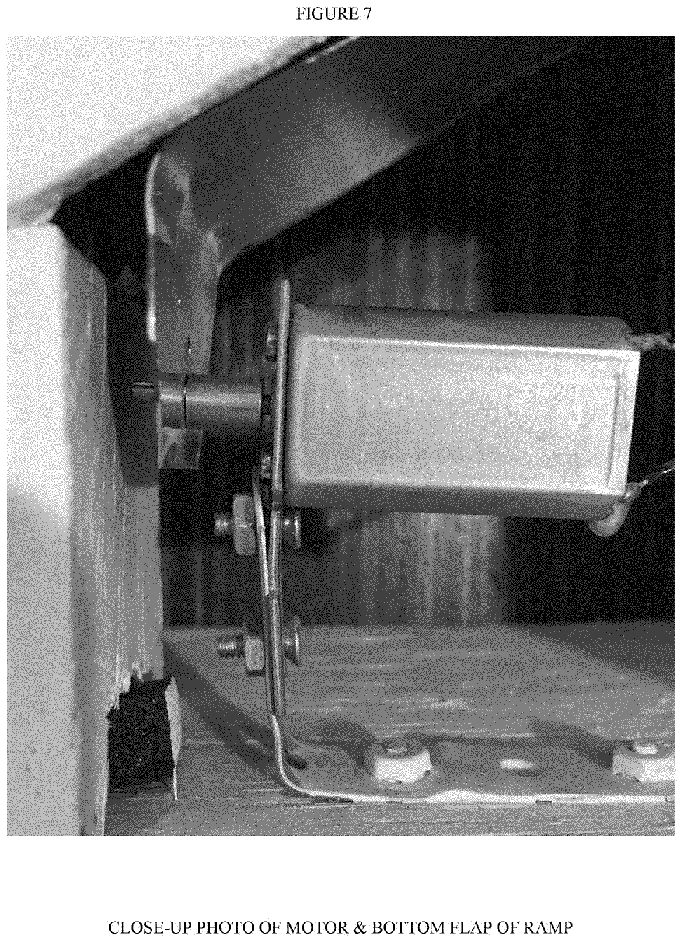

A narrow diameter off-center extension rod extends from the end of the motor's shaft as shown in FIGS. 2, 3, and 7. The motor is mounted to the base of the mixing chamber and immediately beneath the ramp as shown in FIG. 6 & 7. The narrow diameter off-center extension rod protrudes through the hole in the vertical bottom flap of the ramp. The upper rim of the hole in the bottom flap of the ramp rests upon the narrow diameter off-center extension rod as shown in FIG. 7. When the motor runs, the off-center extension rod causes the lower end of the ramp to vibrate up and down.

In another embodiment of the current invention not shown, the motor shaft does not have a narrow diameter off-center extension rod. The shaft circumference itself is elliptical, not cylindrical. The loosely mounted ramp does not have a hole in the bottom end. The bottom of the ramp rests directly upon the elliptical motor shaft. When the shaft rotates, the bottom the ramp vibrates up and down. Other configurations of ramps and motors to prevent the balls from jamming are contemplated by the current invention.

3. The Pool of Recordings Many states that operate lotteries 2-4 times per day generate random numbers by conducting live telecasts of the mixing of differently numbered balls and the identification of the numbers on the randomly separated balls by human eyes. Said method introduces the risk of corruption and requires labor expense. The use of such a method every minute of the day for internet number-selecting games would be prohibitive, even if possible.

In a preferred embodiment of the current invention, the novel concept of pre-producing brief recordings of digits being randomly generated, and then displaying four of the recordings every minute of every day was brought to fruition with novel accomplishments. An I-Phone was mounted on a tripod stand facing the front of a mixing chamber that contained ten differently numbered balls. The I-phone's audio/video mode was activated. An air blower mixed the balls for about ten seconds. The vibrating-ramp motor was then activated for a few seconds. In the hundreds of ball-mixing segments, the balls did not jam once. The digit was announced after each ball settled. The blower was repeatedly re-started until several hundred brief videos of numbered balls being mixed were produced.

About fifteen recordings of each digit being randomly generated were produced. Each recording was trimmed to last about seven seconds. The ten best looking and sounding recordings of each digit being randomly generated were saved and stored in a file and uploaded to a server that hosts the software of the current invention.

Every minute of every day, 1,440 times a day, the software of the current invention randomly selects four of said 100 recordings. None of the four recordings is selected twice in the same minute. Software then displays the four recordings sequentially for 28 seconds.

In an alternate embodiment, portions of the four recordings overlap the others, thereby shortening the total time required to display a randomly generated four-digit number. Additionally, the beginning portions of the running time of each recording can be shortened a bit to allow time to for display of longer advertisements between games.

For purposes of facilitating the random selecting of recordings for each game, in a preferred embodiment of the current invention, each of the ten recordings of each digit being randomly generated has a different three-digit identification number ranging from 400 to 499. The first digit of the identification number represents the historic sequence of the pool of 100. It is a “4” for all 100 recordings of the current invention. Ten of the recordings have a “0” middle digit in their three-digit identification number. Those ten recordings randomly generate a “0” digit. The last digit of the 3-digit identification number of each of the “0” recordings is different from the other nine. The foregoing format is used to apply a 3-digit ID number to the other nine groups of ten balls. This format simplifies the random number generating function of the software by enabling it to randomly select four different three-digit numbers between 400-499 inclusive and to display the recordings represented by said four three-digit numbers.

### 4. Displaying Advertisements Between Free-Play Online Number-Selecting Games

The use of free-play, cash prize four-digit number-selecting games to attract customers to retail stores was disclosed in the prior application. Said games are also used in the current invention. The prior invention was not designed for use on the internet. The current invention was designed for use on the internet.

The current invention comprises the creating of a website for hosting and operating frequent free-play number-selecting games composed of randomly selected recordings of randomly generated digits that form winning numbers, and for displaying advertisements between games and using the advertising revenue to support the games' prize structure. These were novel concepts that reached fruition with novel accomplishments.

Most of the internet advertising sales are consummated by auction. Sellers of time slots declare a minimum price they will accept for a block of ads to fill their time slots. Advertisers bid. The highest bidder wins the auction but pays only the amount declared by the seller.

The cost of internet advertisements can be based upon on a “pay-per-view” or a “pay per click” basis. The prices of “pay-per-view” ads are higher for ads that are viewed in their entirety.

The time required to display four recordings of random numbers being generated is about 28 seconds. That leaves at least 30 seconds for ads. Most of the ads displayed between the number-selecting games of the current invention will be viewed in their entirety because players do not want to miss the thrill of seeing their favorite four-digit number being displayed.

Players of the current invention will be permitted to play one game per day. For every click of an ad, a player will be rewarded with the opportunity to play an additional game. The specific web site screen for each player will indicate how many more games a player can play in that day.

If a player clicks on an ad, the player's selected number will not be matched against the winning number created in the immediate next 30-second time slot. The player can surf the internet until he/she desires and return to the web site to re-submit his/her selected number for comparison to a winning number that will be randomly generated as soon as the player return to the web site. The player will be permitted to play an additional game the same day instead of being limited to one game a day.

A preferred embodiment of the current invention includes spread sheet software that stores player IDs, date and time of play, number selected, game number, email address, and “ad-per-click” incidence and time.

In a preferred embodiment of the current invention, the initial prize amount has been set at $250.00. With a four-digit winning number, a match will once every 10,000 plays. That averages to a cost per play per player of 2.5 cents.

Online advertisements sponsored by popular internet companies generate an average of $1.72 per click. An average expected click rate will be 2.0% of the ads displayed. If one ad is displayed before every number-selecting game, about 200 ads will be clicked on every 10,000 games. That will generate $344.00 in revenue from advertising and will be enough to cover the cost of the $250.00 prize and a profit. As the advertising revenue increases, the amount of the prizes will be increased, thereby attracting more players.

1. Apparatus for advertising frequently on the internet comprising: a plurality of random digit generating means each means comprised of: transparent enclosure means containing ten balls, each of said balls being conspicuously marked with a different digit; means for mixing said balls; ramp means upon which said balls travel, the upper end of said ramp means being loosely attached near the back of said enclosure; small motor means, the rotating shaft of said motor means being eccentrically configured and said motor means positioned in such a manner that the bottom of said ramp means rests upon on said shaft and moves upward and downward when said shaft rotates.

2. The apparatus for advertising frequently on the internet described in claim 1 also comprising: means for producing a pool of video recordings of digits being randomly generated by mixing ten differently numbered balls in an enclosed chamber until one ball randomly separates itself from the others, said pool of recordings containing an equal quantity of recordings of each digit being randomly generated; means for randomly selecting a plurality of differing recordings from said pool; means for displaying said plurality of selected recordings on the internet; means for causing the winning numbers of said online games to be composed of the randomly generated digits displayed in said selected recordings; means for displaying said winning numbers; means for displaying advertisements before and after displaying said winning numbers.

3. The apparatus for advertising frequently on the internet described in claim 1 wherein said balls are mixed by air blowing means.

4. The apparatus for advertising frequently on the internet described in claim 1 wherein said balls are mixed by mechanical paddle means.

5. The apparatus for advertising frequently on the internet described in claim 1 wherein said balls are mixed by rotating means.

6. The apparatus for advertising frequently on the internet described in claim 1 wherein said small motor means is mounted to said chamber below the center and near the bottom of said ramp, the bottom of said ramp having a hole in it and the end of the shaft of said motor having a small cylindrical off-center member extending from the end of said shaft, said off-center member projecting through said hole in the ramp, and the bottom of said ramp moving up and down as said shaft rotates.

7. The apparatus for advertising frequently on the internet described in claim 1 wherein the bottom end of said ramp has a downward flap, said flap having a hole near its center and said off-center member extending from said shaft and protruding through said hole.

8. The apparatus for advertising frequently on the internet described in claim 1 wherein the bottom end of said ramp rests on a portion of said shaft of said motor and said portion of said shaft of said motor is eccentrically shaped and said shaft of said motor causes the bottom of said ramp to move up and down as it rotates.

9. Software for advertising frequently on the internet comprising: means for permitting internet users and television viewers to select numbers without paying anything and to win big cash prizes playing online number games if said selected numbers become matched by randomly generated winning numbers, said software also comprising means for displaying advertisements before and after displaying said winning numbers.

10. The software described in claim 9 wherein said winning numbers are composed of digits that were randomly generated by mixing ten differently numbered balls in an enclosed chamber until one ball randomly separated itself from the others, said software also comprising means for displaying said winning numbers; means for displaying advertisements before and after displaying said winning numbers.

11. A method of advertising frequently on the internet comprising the following steps: produce a pool of video recordings of digits being randomly generated, each of said recordings being different from all others, said pool containing an equal quantity of recordings of each digit being randomly generated; randomly select a plurality of said recordings from said pool and display them on the internet at frequent intervals during every hour of the day; create winning numbers consisting of the randomly generated digits displayed in said recordings; display said winning numbers on the internet at said frequent intervals; enable players to select numbers without paying anything; award big cash prizes to the players who select numbers that become matched by certain winning numbers; display advertisements on the internet before and after displaying said winning numbers.

12. The method of advertising frequently on the internet described in claim 11 wherein said intervals are one minute.

13. The method of advertising frequently on the internet described in claim 11 wherein said plurality consists of four.

14. The method of advertising frequently on the internet described in claim 11 wherein said plurality consists of four and wherein said intervals are one minute.

15. The method of advertising frequently on the internet described in claim 11 wherein said digits are generated by mixing ten differently numbered balls in an enclosed chamber until one ball randomly separates itself from the others.

16. The method of advertising frequently on the internet described in claim 11 wherein four non-identical recordings are randomly selected from said pool and the resulting winning number consists of the four digits randomly generated in said four selected recordings.

17. The method of advertising frequently on the internet described in claim 11 plus the step of assigning identification numbers to each of said recordings in said pool, said identification numbers consisting of three digits that are numerically successive and identify the digit that was randomly generated.

18. The method of advertising frequently on the internet described in claim 11 wherein eligibility for winning a prize does not depend upon viewing an ad completely or clicking on an ad.

19. The method of advertising frequently on the internet described in claim 11 plus the step of using a portion of the revenue generated by said advertising to pay the prizes.

20. The method of advertising frequently on the internet described in claim 11 wherein the advertisements and winning numbers are also displayed on television.
